(19) United States
(12) Patent Application Publication
(10) Pub. No.: US 2005/0144164 A1
(43) Pub. Date: Jun. 30, 2005

(54) SYSTEM FOR STORING AND SEARCHING FOR TAGS IN DATA STREAM AND METHOD FOR STORING AND SEARCHING FOR TAGS IN DATA STREAM

(75) Inventors: Gracjan GORAK, Zielona Gora (PL); Jaroslaw MIRKOWSKI, Zielona Gora (PL); Adam PAWLOWSKI, Lodz (PL)

Correspondence Address: SCHOLL PATENT AGENCY, INC.;DR. MATTHIAS SCHOLL, 800 MAIN ST, #308, HOLDEN, MA, 01520, US

(73) Assignees: ADVANCED DIGITAL BROADCAST POLSKA SPOLKA Z O.O., Zielona Gora (PL); ADVANCED DIGITAL BROADCAST LTD., Hsin-Tien City (TW)

(21) Appl. No.: 10/905,318

(22) Filed: Dec. 28, 2004

(30) Foreign Application Priority Data
Dec. 30, 2003 (PL) P-364275

(51) Int. Cl. G06F 17/30

(52) U.S. Cl. 707/5

(57) ABSTRACT

In a system for storing and searching for tags in a data stream, a signal processing block (120) contains a tag analysis block (121) providing functionality of procedures of searching and storing tags within an audio/video data stream. The tag analysis block (121) is provided with a configuration table (122) for storing configuration data for various types of recordings, defining distances of searching and storing tags. In this system a user tag is inserted at a place of existing tag when an existing tag distance is shorter or equal to a predefined tag searching distance. Otherwise, when there is no existing tag within the predefined tag searching distance, the user tag is inserted at the predefined tag searching distance.

### CROSS-REFERENCE TO RELATED APPLICATIONS

This application claims priority to Polish Application No. P-364275, filed Dec. 30, 2003, the contents of which are incorporated herein by reference.

### BACKGROUND OF THE INVENTION

1. Field of the Invention

The present invention relates to a system for storing and searching for tags in a data stream and a method for storing and searching for tags in a data stream, especially in an audio/video data stream with tags.

2. Brief Description of the Background of the Invention Including Prior Art

The well-known VCR (Video Cassette Recorder) and DVR (Digital Video Recorder) devices enable the user to browse through the recorded material with increased playback speed, using the “rewind” and “fast forward” functions. These functions enable the user to search the recording for a specific scene, but when that scene is at a far distance from the current recording position, it takes considerable time. Moreover, after the scene is found, it is difficult to resume playback from its exact beginning. The digital recordings may be enhanced by scene tags, identifying the beginning of each scene. However, the currently known methods to find a desired scene employ a mosaic of images from which a user can select a scene, which is also a time-consuming process.

From a PCT publication No. WO03067594 “Centralized digital video recording system with bookmarking” there is known a digital video recording system, in which users may establish bookmarks in order to pause and resume programs. Each user has access both to the bookmarks set by that user and by other users. The bookmark points can be presented on a progress bar of the replayed recording, or by means of a matrix of images, or in form of a list. The drawback of that system is that it does not enable easy returning to the beginning of the current scene, and it does not allow setting a bookmark with a delay.

From the American patent application No. US/2002/0006266 “Record/play apparatus and method for extracting and searching index simultaneously” there is known a set-top box with an automatic indexing/search device, which enables the user to store index information about recording by automatically extracting meaningful information from the stream. Although it is mentioned that such indexes may allow later non-linear playback of the recording, no specific playback method is provided.

From the American application No. US/2003/123850 “Intelligent news video browsing system and method thereof” there is known a method allowing a user to conveniently browse news recordings, containing indexes which define the type of a specific recording scene. When the recording is browsed, the scenes of different types may be replayed with different speed, depending on the scene type. That method refers to automatic playback, without interference of the user.

One of the drawbacks of the current replay systems is that the user can insert tags only at the current place for the replayed recording. If the user wishes to insert a tag at the beginning of a scene, the recording should be exactly positioned manually (for example, by rewinding the recording if a scene already started). This is time-consuming and disturbs watching of the recording.

### SUMMARY OF THE INVENTION

Purposes of the Invention

It is an object of the present invention to provide a method for determining a location of beginning of a current or a next scene in an easier way than proposed by methods known form prior art.

It is a further object of the present invention to provide a method allowing insertion of tags in place of the beginning of scene being watched.

These and other objects and advantages of the present invention will become apparent from the detailed description, which follows.

### BRIEF DESCRIPTION OF THE INVENTION

A system for storing and searching for tags in a data stream has a signal receiving block, a signal processing block linked to the signal receiving block and a digital video recording block and an audio/video block linked to the signal processing block. The signal processing block contains a tag analysis block providing functionality of procedures of searching and storing tags within an audio/video data stream. In turn the tag analysis block comprises a configuration table for storing configuration data for various types of recordings, defining distances of searching and storing tags.

The signal processing block can be a software module.

A method for storing and searching for tags in a data stream comprises the steps of searching for an existing tag in a predefined tag searching distance within the data stream and inserting a user tag at a place of the existing tag when the existing tag is within the distance shorter or equal to the predefined tag searching distance or inserting the user tag at the predefined tag searching distance when there is no existing tag within the predefined tag searching distance.

The predefined tag searching distance can be read from the data stream.

The method can further comprise determining the type of program contained in the data stream and reading the predefined tag searching distance specified for the determined type of program from a configuration table, comprising data on tag searching distances for various types of programs.

The method can also comprise setting the predefined tag searching distance equal to a default value when the tag searching distance is not defined in the configuration table for the determined type of program.

During backwards searching, the method can comprise the steps of searching for a next existing tag in the predefined tag searching distance when a distance to the existing tag is shorter than an allowed command delay.

Instead of inserting the user tag a command of playing back the data stream is executed.

The novel features, which are considered as characteristic for the invention are set forth in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

In the accompanying drawings one of the possible embodiments of the present invention is shown, where:

FIG. 1 is a structure of a digital television decoder with a digital video recording system;

FIG. 2 is a playback process;

FIG. 3 is a procedure of handling user commands;

FIG. 4 is a procedure of defining a tag searching distance;

FIG. 5 is a configuration table, defining tag searching parameters;

FIG. 6 is a procedure of handling an allowed command delay at a shift of recording backwards;

FIG. 7 is a procedure of a final phase of handling a user command.

### DESCRIPTION OF INVENTION AND PREFERRED EMBODIMENT

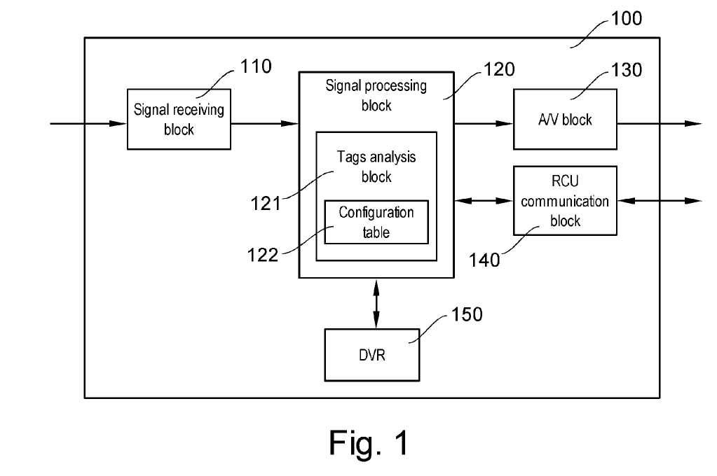

FIG. 1 illustrates a structure of a digital television decoder 100 with a digital video recording (DVR) system 150. The DVR system 150 can be built in the decoder or connected externally. The decoder 100 contains a signal receiving block 110, which receives the audio/video data stream, for example digital television signal, or signal from a portable data carriers reader, e.g. DVD player. The signal is passed from the signal receiving block 110 or from the DVR system 150 to the signal processing block 120, where it is decoded and descrambled, and from where it is passed to the audio/video block 130. The signal processing block 120 may also direct data stream from the signal receiving block to a DVR system 150, while reading another stream from the DVR system 150. The audio/video block 130 converts the signal to a form acceptable by a TV set, for example PAL or NTSC system. The decoder also contains a block 140 for communication with a remote control unit (RCU), for receiving commands from the RCU.

The signal processing block 120 contains a tag analysis block 121, which provides functionality of the procedures of searching, recognizing and storing the tags in the audio/video stream, i.e. the recording stored in the DVR system. In alternative embodiment, the tag analysis block 121 may comprise a configuration table 122 for storing configuration data for various types of recordings. The tag analysis block 121 may be a software module. The tags used in the presented solution, are bookmarks in the recording which mark the beginning of the scenes. The tags may be defined by the recording provider or the user. For example, they can mark certain fragments of the movie, or most interesting scenes.

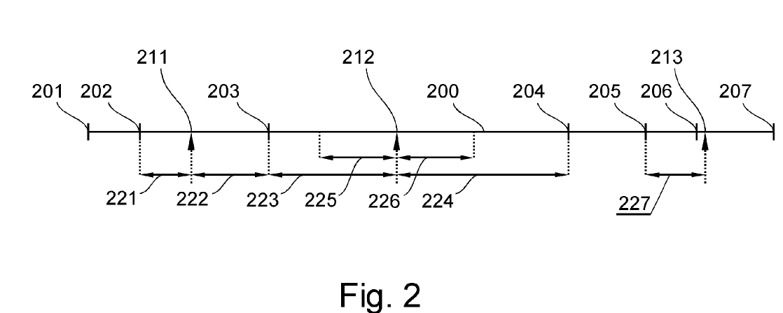

FIG. 2 presents the exemplary process of playback of the recording 200 with tags 201-207. The recording is illustrated by a horizontal line and the tags are marked with small perpendicular lines. The arrows 211, 212 and 213 illustrate points in the recording at which the user invoked specific commands.

If the event at the first point 211 refers to a command to shift the recording backward for a distance 221, the playback of the recording is resumed from the place, where the closest tag 202 is located. If the event refers to a command to shift the recording forward for a distance 222, the playback of the recording is resumed from the tag 203. If the event refers to a command to insert a user tag at the beginning of the scene, it is inserted in the place of the tag 202. If the event refers to a command to insert a user tag at the end of the scene, it is inserted in the place of the tag 203.

The second point 212 is at a considerable distance 224 from the tag following it 204. The user might not be interested in moving the recording forward at such big distance. To solve this problem, the method according to the invention introduces the “tag searching distance” parameter, which defines the longest distance of shift within the recording. If there is no tag within this distance, the recording will be shifted back only by a distance of 225, or the tag will be insert at a distance 225 before the current position. In case of moving the recording forward, it will be shifted at a distance of 226, or a tag will be inserted at a distance 226 after the current position.

The third point 213 is close to the last tag 206. If a user issues a shift backwards command at this point, it is probable that the user is interested in to the beginning of the previous scene (for example, the user shifted backwards to the beginning of the scene and would like to shift even further backwards). To solve this problem, the method according to the invention introduces the parameter “allowed command delay”, which defines the maximum time span between the execution of command and the tag of the beginning of the current scene, for which the recording is shifted backwards to the beginning of a previous scene 205. This parameter is used only for the command of moving the recording backward. The commands of moving the recording forward and inserting the user tag are independent from this parameter, so the user tag would be inserted at the place of the tag 206, and the recording would be shifted forward to the tag 207.

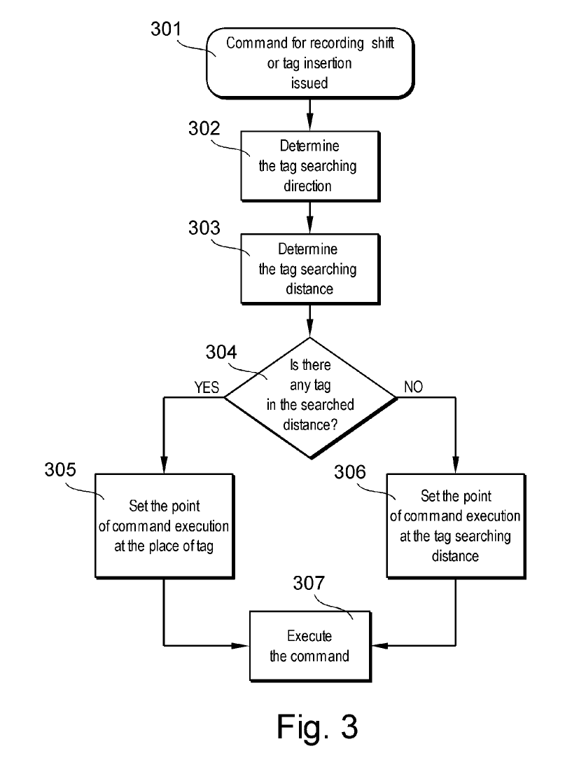

FIG. 3 presents the procedure of handling user commands. It is activated in step 301, when a command for recording shift or tag insertion is issued. Next, the direction of tag searching is determined in step 302 basing on the issued command. Next, in step 303 the parameters of tag searching are determined. For all commands the searching distance is determined, and for the command of moving backward the allowed command delay is determined as well. In the simplest embodiment of the system, these parameters can be fixed for all types of recordings. In a more elaborate embodiment, these parameters can be added to the recording by its producer, or can be defined on basis of the type of the recording. Next, in step 304 it is checked if the tag is located within the searched distance and in the specific direction from the current place. If the tag is found, the place of execution of the command is settled in the place of this tag in step 305. If there is no tag within the searched distance, then, in step 306 the place of execution of the command is settled within the tag searching distance in specific direction from the current place. Next, in step 307 the command issued by the user is executed in a specific place: a tag is inserted or playback is resumed.

Moving to a place located at the distance of the searching distance allows to shift along the recording by steps, for example at one minute steps. In another embodiment, if a tag is not found, instead of the step shift at the tag searching distance, the recording may be played with higher speed in a specific direction, until a tag is found or a “stop” command is issued by the user.

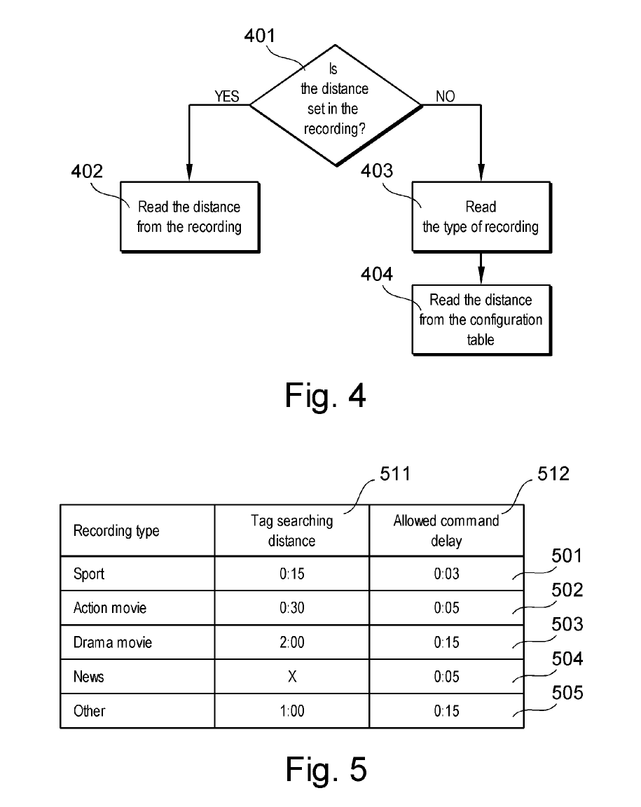

FIG. 4 shows the procedure of defining the tag searching parameters in a more complex embodiment of the system, executed as the extension of step 303 from FIG. 3. At the beginning in step 401 it is checked if there are any tag searching parameters embedded in the recording. If found, they are read in step 402 and used for tag searching. If there are no parameters in the recording, the type of the recording is read in step 403, and next in step 404 the parameters are specified on the basis of data from the configuration table.

FIG. 5 presents the configuration table, which consists of lines 501, 502, 503, 504, 505 and columns 511 and 512, which define tag searching parameters: the tag searching distance in column 511 and the allowed command delay for various types of recordings in column 512. For example, the parameters can be smaller for sports programs or action movies, because the action changes there more often than in for example classic movies. In line 504 an indefinite value (X) for tag searching distance is set, which means that the tag will not be searched and the recording will be always shifted to a previous or a next tag, regardless of the distance to that tag. This can be useful for example for recordings with news, where the user is mostly interested in moving to the next or the previous scene. The table also includes default parameters for recordings with undefined or unknown type in line 505.

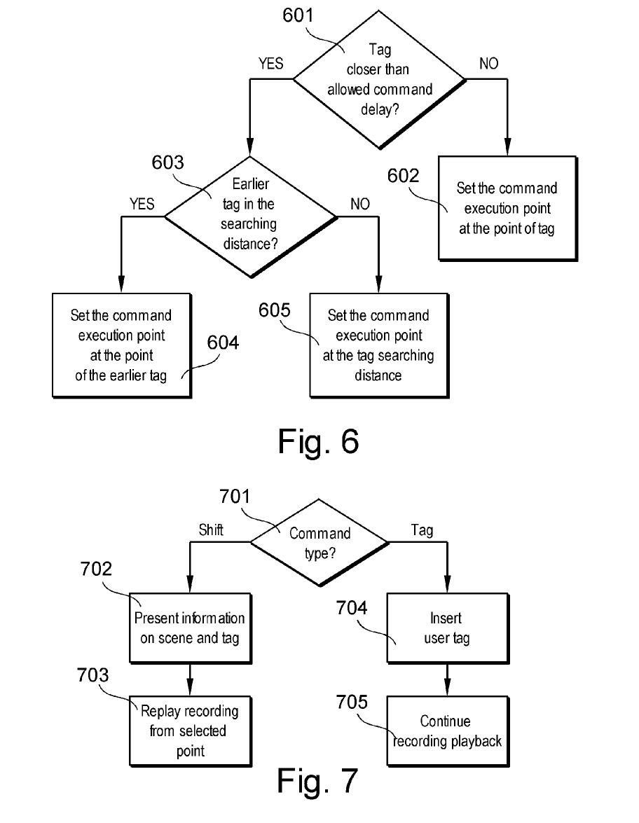

FIG. 6 presents the procedure of handling the allowed command delay when moving the recording backward. It is performed as the extension of step 305 from FIG. 3. This procedure allows moving the recording backward to the scene preceding the current scene, if the command is issued shortly after the start of the current scene. In the first step 601 the procedure checks if there is a tag at a distance smaller than the allowed command delay. If the distance is longer, the command execution point is set at the point of tag in step 602. In case of shorter distance, the procedure checks in step 603 if another tag, indicating the beginning of a previous scene, is located within the distance of tag searching. If there is such tag, the place of executing the command is defined in place of the preceding tag in step 604. If not, the place of executing the command is defined in step 605 at the distance of tag searching.

FIG. 7 illustrates the procedure of the final phase of handling the user command, which is an extension of step 307 from FIG. 3. The procedure starts in step 701, by checking the type of the command. If the command refers to moving the recording, in step 702 the procedure presents information about the scene, to which the recording was shifted, as well as a description of a tag, if the recording was shifted to a tag. Information about the scene may include a short description of the scene, and the description of a tag can inform if it is a tag inserted by the user or the producer. Next, in step 703 the procedure resumes the playback of the recording from the place dependent on the issued command. If the command refers to inserting the user tag, then in step 704 the procedure inserts the user tag in place of execution of the command, at the place of already existing tag, or at the distance of tag searching, and next in step 705 the procedure continues playback of the recording.

The advantage of the present invention is enabling easier location of the beginning of the current or the next scene and insertion of tags in place of the beginning of the current scene. The well-known functions of playback with increased speed (rewind, fast forward) are replaced by the step shift of the recording to the place of the tag or for a specific distance. The well-known function of inserting the tag in the currently watched place is replaced by the function of inserting the tag in place of the beginning of the current scene, or at a specific distance from the currently watched place.

The system is designed for handling various types of recordings, for example movies on portable carriers, or television programs recorded on DVR devices. The system handles recordings with tags. If recordings do not have tags, the system will allow step shifts and insertion of tags at the predefined distance.

It will be understood that each of the elements described above, or two or more together, may also find a useful application in other types of systems for storing and searching for tags from the types described above.

While the invention has been illustrated and described as embodied in the context of a system for storing and searching for tags in an audio/video data stream with tags, it is not intended to be limited to the details shown, since various modifications may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A system for storing and searching for tags in a data stream comprising
a signal receiving block (110);
a signal processing block (120) linked to the signal receiving block (110) and containing a tag analysis block (121) providing functionality of procedures of searching and storing tags within an audio/video data stream and comprising a configuration table (122) for storing configuration data for various types of recordings, defining distances of searching and storing tags; and
a digital video recording block (150) and an audio/video block (130) linked to the signal processing block (120).

2. The system for storing and searching for tags according to claim 1, wherein the signal processing block (120) is a software module.

3. A method for storing and searching for tags in a data stream comprising following steps:
searching for an existing tag in a predefined tag searching distance within the data stream; and
inserting a user tag at a place of the existing tag when the existing tag is within a distance shorter or equal to the predefined tag searching distance or inserting the user tag at the predefined tag searching distance when no tags were found within the predefined tag searching distance.

4. The method according to claim 3 wherein the predefined tag searching distance is read from the data stream.

5. The method according to claim 3 further comprising the following steps:
determining the type of program contained in the data stream; and
reading the predefined tag searching distance specified for the determined type of program from a configuration table, comprising data on predefined tag searching distances for various types of programs.

6. The method according to claim 5 further comprising the following step:
setting the predefined tag searching distance equal to a default value when the predefined tag searching distance is not defined in the configuration table for the determined type of program.

7. The method according to claim 3 further comprising the following step:
searching for a next existing tag in the predefined tag searching distance during backwards searching when a distance to the existing tag was shorter than an allowed command delay.

8. The method according to claim 3 wherein instead of inserting the user tag a command of playing back the data stream is executed.

9. A method for storing and searching for tags in a data stream comprising following steps:
searching for an existing tag in a predefined tag searching distance within the data stream; and
executing a user command at a place of the existing tag when the existing tag is within a distance shorter or equal to the predefined tag searching distance or executing the user command at the predefined tag searching distance when no tags were found within the predefined tag searching distance.

10. The method according to claim 9 wherein the predefined tag searching distance is read from the data stream.

11. The method according to claim 9 further comprising the following steps:
determining the type of program contained in the data stream; and
reading the predefined tag searching distance specified for the determined type of program from a configuration table, comprising data on predefined tag searching distances for various types of programs.

12. The method according to claim 11 further comprising the following step:
setting the predefined tag searching distance equal to a default value when the predefined tag searching distance is not defined in the configuration table for the determined type of program.

13. The method according to claim 9 further comprising the following step:
searching for a next existing tag in the predefined tag searching distance during backwards searching when a distance to the existing tag is shorter than an allowed command delay; and
executing the user command at a place of the next existing tag.

14. The method according to claim 9 wherein the user command is inserting a user tag.

15. The method according to claim 9 wherein the user command is playing back the data stream.
